(19) United States
(12) Patent Application Publication
(10) Pub. No.: US 2011/0053003 A1
(43) Pub. Date: Mar. 3, 2011

(54) LITHIUM ION SECONDARY BATTERY AND METHOD FOR PRODUCING LITHIUM ION SECONDARY BATTERY

(76) Inventor: Masaki Deguchi, Hyogo (JP)

(21) Appl. No.: 12/991,400

(22) PCT Filed: Feb. 4, 2010
(86) PCT No.: PCT/JP2010/000687

§ 371 Date: Nov. 5, 2010

(30) Foreign Application Priority Data
Feb. 6, 2009 (JP) 2009-026469

(51) Int. Cl. H01M 10/0569; H01M 10/00

(52) U.S. Cl. 429/336; 429/340; 29/623.2

(57) ABSTRACT

The invention relates to a lithium ion secondary battery including: a positive electrode, a negative electrode, a separator disposed between the positive electrode and the negative electrode, and a non-aqueous electrolyte, wherein the non-aqueous electrolyte includes a non-aqueous solvent including a sulfone compound, the positive electrode includes a positive electrode current collector and a positive electrode active material layer formed on the surface of the positive electrode current collector, the positive electrode active material layer includes lithium-containing composite oxide particles and a fluorocarbon resin, and a coverage of the fluorocarbon resin relative to the surface area of the lithium-containing composite oxide particles is 20 to 65%. It is an object of the invention to provide a lithium ion secondary battery that is kept from deteriorating in rate characteristics over time, in particular, from significantly deteriorating in rate characteristics during storage at high temperatures.

### TECHNICAL FIELD

The present invention relates to a lithium ion secondary battery including a lithium-containing composite oxide as a positive electrode active material, and a method for producing the same.

### BACKGROUND ART

In general, lithium ion secondary batteries include a positive electrode containing a lithium-containing composite oxide as the active material, a negative electrode containing a carbon material as the active material, a separator made of a polyethylene or polypropylene microporous film, and a non-aqueous electrolyte.

A solution in which a lithium salt is dissolved in a non-aqueous solvent can be used as the non-aqueous electrolyte. Lithium hexafluorophosphate (LiPF₆), lithium tetrafluoroborate (LiBF₄), and the like are known as the lithium salt. Cyclic carbonic acid esters, chain carbonic acid esters, cyclic carboxylic acid esters, and the like are known as the non-aqueous solvent.

Fluorinated organic ether compounds are also known as the non-aqueous solvent. The electrolytes for lithium ion secondary batteries described in Patent Document 1 and Patent Document 2 contain an organic fluorinated ether compound as the non-aqueous solvent.

Fluorinated organic ether compounds have a high oxidation potential and low viscosity, and therefore are stable components that are resistant to oxidative decomposition even under a voltage exceeding 4 V. Further, they show high ionic conductivity at low temperatures. Therefore, lithium ion secondary batteries using a non-aqueous solvent containing a fluorinated organic ether compound can be considered to exhibit a relatively small decrease in battery capacity and good cycle characteristics.

Incidentally, when a lithium ion secondary battery using a lithium-containing composite oxide as a positive electrode active material is stored at a high temperature, metal cations other than lithium ions are prone to be eluted into a non-aqueous electrolyte. Then, thus eluted metal cations will be precipitated as metals on a negative electrode and a separator through charging and discharging. The metals that have been precipitated on the negative electrode cause an increase in the impedance of the negative electrode. The metals that have been precipitated on the separator cause clogging of micropores. Such phenomena result in deterioration in the rate characteristics of the lithium ion secondary battery.

Patent Document 1: Japanese Laid-Open Patent Publication No. Hei 7-249432

Patent Document 2: Japanese Laid-Open Patent Publication No. Hei 11-26015

### DISCLOSURE OF THE INVENTION

### Problem to be Solved by the Invention

It is an object of the present invention to provide a lithium ion secondary battery that is kept from deteriorating in rate characteristics over time, in particular, from significantly deteriorating in rate characteristics during storage at a high temperature.

### Means for Solving the Problem

One aspect of the present invention is a lithium ion secondary battery including: a positive electrode, a negative electrode, a separator disposed between the positive electrode and the negative electrode, and a non-aqueous electrolyte, wherein the non-aqueous electrolyte includes a non-aqueous solvent including a sulfone compound, the positive electrode includes a positive electrode current collector and a positive electrode active material layer formed on the surface of the positive electrode current collector, the positive electrode active material layer includes lithium-containing composite oxide particles and a fluorocarbon resin, and a coverage of the fluorocarbon resin relative to the surface area of the lithium-containing composite oxide particles is 20 to 65%.

Another aspect of the present invention is a method for producing a lithium ion secondary battery, including the steps of: (A) applying a material mixture including lithium-containing composite oxide particles and a fluorocarbon resin to the surface of a positive electrode current collector, followed by drying and rolling, to form a positive electrode active material layer, thereby obtaining a positive electrode; (B) heat-treating the positive electrode to melt or soften the fluorocarbon resin; (C) producing an electrode group by laminating the heat-treated positive electrode, a negative electrode, and a separator disposed between the positive electrode and the negative electrode; and (D) housing the electrode group and a non-aqueous electrolyte in a battery case, and sealing the battery case; wherein the non-aqueous electrolyte includes a non-aqueous solvent including a sulfone compound, a ratio of the fluorocarbon resin mixed in the material mixture is 0.7 to 8 parts by weight, per 100 parts by weight of the lithium-containing composite oxide particles, and the heat treatment is performed under such a condition that a coverage of the fluorocarbon resin relative to the surface area of the lithium-containing composite oxide particles becomes 20 to 65%.

### EFFECT OF THE INVENTION

According to the present invention, it is possible to provide a lithium ion secondary battery that is kept from deteriorating in rate characteristics over time, in particular, from significantly deteriorating in rate characteristics during storage at a high temperature.

Objects, features, aspects, and advantages of the present invention will become more apparent from the following detailed description and the appended drawings.

### BRIEF DESCRIPTION OF THE DRAWINGS

FIG. 1 is a schematic vertical cross-sectional view showing one embodiment of a lithium ion secondary battery according to the present invention.

FIG. 2 is a schematic vertical cross-sectional view illustrating a positive electrode of a lithium ion secondary battery according to the present invention.

### BEST MODE FOR CARRYING OUT THE INVENTION

A lithium ion secondary battery according to one embodiment of the present invention will be described.

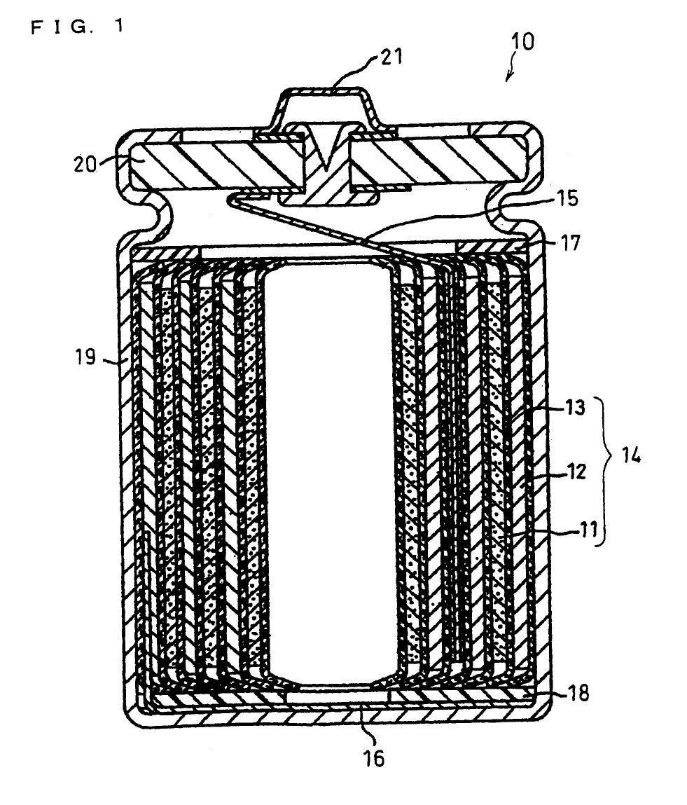

FIG. 1 is a schematic vertical cross-sectional view of a cylindrical lithium ion secondary battery 10 according to this embodiment.

The lithium ion secondary battery 10 includes a positive electrode 11, a negative electrode 12, a separator 13 separating the positive electrode 11 and the negative electrode 12 from each other, and a non-aqueous electrolyte (not shown). The positive electrode 11, the negative electrode 12, and the separator 13 are laminated to form an electrode group 14. The electrode group 14 is wound in a spiral. The positive electrode 11 is electrically connected to one end of a positive electrode lead 15. The negative electrode 12 is electrically connected to one end of a negative electrode lead 16. A positive electrode-side insulating plate 17 is mounted on one end, in the winding axis direction, of the electrode group 14, and a negative electrode-side insulating plate 18 is mounted on the other end. The electrode group 14 is housed in a battery case 19, together with the non-aqueous electrolyte. The battery case 19 is hermetically sealed by a sealing plate 20. The battery case 19 also serves as a negative electrode terminal and is electrically connected to the negative electrode lead 16. A positive electrode terminal 21 attached to the sealing plate 20 is electrically connected to the positive electrode lead 15.

First, the positive electrode 11 of this embodiment will be described in detail.

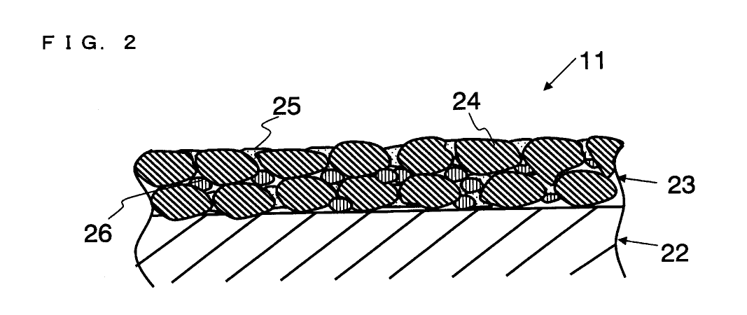

As shown in FIG. 2, the positive electrode 11 includes a positive electrode current collector 22 and a positive electrode active material layer 23 formed on the surface of the positive electrode current collector 22.

Various current collectors that can be used as the current collector of the positive electrode of lithium ion secondary batteries may be used as the positive electrode current collector. Specific examples thereof include aluminum or an alloy thereof, stainless steel, and titanium. Of these, aluminum and an aluminum-iron alloy are particularly preferable. The shape of the positive electrode current collector may be any of foil, membrane, film, and sheet forms. The thickness of the positive electrode current collector may be appropriately set according to the capacity, size, and the like of the battery. Specifically, it is preferable that the thickness is selected within the range of 1 to 500 pm, for example.

The positive electrode active material layer 23 contains a positive electrode active material 24, a fluorocarbon resin 25 as a binder, and a conductive material 26.

Lithium-containing composite oxide particles can be used as the positive electrode active material 24.

As a specific example of the lithium-containing composite oxide, a lithium-containing composite oxide represented by general formula (1) below is preferable in terms of the crystal structure stability.

LiₓM_{y}Me_{1-y}O_{2+δ} (1)

wherein M represents at least one element selected from the group consisting of nickel (Ni), cobalt (Co), and manganese (Mn); Me represents at least one element selected from the group consisting of magnesium, aluminum, zinc, iron, copper, chromium, molybdenum, zirconium, scandium, yttrium, lead, boron, antimony, and phosphorus; x is in the range of 0.98 to 1.1; y is in the range of 0.1 to 1; and δ is in the range of −0.1 to 0.1.

In general formula (1), x represents the atomic ratio of lithium (Li). y represents the atomic ratio of M, which includes at least one element selected from the group consisting of Ni, Co, and Mn.

Me includes elements other than Li, Ni, Co, Mn, and oxygen. Specific examples thereof include metallic elements such as magnesium (Mg), aluminum (Al), zinc (Zn), iron (Fe), copper (Cu), chromium (Cr), molybdenum (Mo), zirconium (Zr), scandium (Sc), yttrium (Y), and lead (Pb); metalloid elements such as boron (B) and antimony (Sb); and nonmetallic elements such as phosphorus (P). Of these, metallic elements are particularly preferable, and Mg, Al, Zn, Fe, Cu, and Zr are more preferable. These elements may be contained alone or in a combination of two or more.

δ represents an oxygen deficiency or an oxygen excess. Ordinarily, an oxygen deficiency or an oxygen excess may be, but are not limited to, in the range of −0.1 to 0.1, which is ±5% of the stoichiometric composition, and preferably in the range of −0.02 to 0.02, which is ±1% of the stoichiometric composition.

Specific examples of the lithium-containing composite oxide represented by general formula (1) include the following compounds.

Ternary composite oxides of lithium, nickel, and cobalt such as LiNi_{0.1}Co_{0.9}O₂, LiNi_{0.3}Co_{0.7}O₂, LiNi_{0.5}Co_{0.5}O₂, LiNi_{0.7}Co_{0.3}O₂, LiNi_{0.8}Co_{0.2}O₂, and LiNi_{0.9}Co_{0.1}O2; quaternary composite oxides of lithium, nickel, cobalt, and element Me such as LiNi_{0.8}Co_{0.15}Al_{0.05}O₂, LiNi_{0.82}Co_{0.15}Al_{0.03}O₂ LiNi_{0.84}Co_{0.15}Al_{0.01}O₂, LiNi_{0.845}Co_{0.15}Al_{0.005}O₂, LiNi_{0.8}Co_{0.15}Sr_{0.05}O₂, LiNi_{0.8}Co_{0.15}Y_{0.05}O₂, LiNi_{0.8}Co_{0.15}Zr_{0.05}O₂, LiNi_{0.8}Co_{0.15}Ta_{0.05}O₂, LiNi_{0.8}Co_{0.15}Mg_{0.05}O₂, LiNi_{0.8}Co_{0.15}Ti_{0.05}O₂, LiNi_{0.8}Co_{0.15}Zn_{0.05}O₂, LiNi_{0.8}Co_{0.15}B_{0.05}O₂, LiNi_{0.8}Co_{0.15}Ca_{0.05}O₂, LiNi_{0.8}Co_{0.15}Cr_{0.05}O₂, LiNi_{0.8}Co_{0.15}Si_{0.05}O₂LiNi_{0.8}Co_{0.15}Ga_{0.05}O₂, LiNi_{0.8}Co_{0.15}Sn_{0.05}O₂, LiNi_{0.8}Co_{0.15}P_{0.05}O₂, LiNi_{0.8}Co_{0.15}V_{0.05}O₂, LiNi_{0.8}Co_{0.15}Sb_{0.05}O₂, LiNi_{0.8}Co_{0.15}Nb_{0.05}O₂, LiNi_{0.8}Co_{0.15}Mo_{0.05}O₂, LiNi_{0.8}Co_{0.15}W_{0.05}O₂, and LiNi_{0.8}Co_{0.15}Fe_{0.05}O₂; quinary composite oxides of lithium, nickel, cobalt, and (two) elements Me such as LiNi_{0.8}Co_{0.15}Al_{0.03}Zr_{0.02}O₂, LiNi_{0.8}Co_{0.15}Al_{0.03}Ta_{0.02}O₂, LiNi_{0.8}Co_{0.15}Al_{0.03}Ti_{0.02}O₂, and LiNi_{0.8}Co_{0.15}Al_{0.03}Nb_{0.02}O₂; ternary composite oxides of lithium, nickel, and manganese such as LiNi_{0.5}Mn_{0.50}O₂ and LiNi_{0.3}Mn_{0.70}O₂; quaternary composite oxides of lithium, nickel, manganese, and cobalt such as LiNi_{0.5}Mn_{0.4}Co_{0.10}O₂, LiNi_{0.5}Mn_{0.3}Co_{0.2}O₂, and LiNi_{1/3}Mn_{1/3}Co_{1/3}O₂; quinary composite oxides of lithium, nickel, manganese, cobalt, and elements Me such as LiNi_{0.33}Mn_{0.33}Co_{0.29}Al_{0.05}O₂, LiNi_{0.33}Mn_{0.33}Co_{0.31}Al_{0.03}O₂, LiNi_{0.33}Mn_{0.33}Co_{0.33}Al_{0.01}O₂, and LiNi_{0.33}Mn_{0.33}Co_{0.33}Y_{0.01}O₂; as well as LiNiO₂, LiCoO₂, LiCO_{0.98}Mg_{0.02}O₂, and LiMnO₂.

Examples of lithium-containing composite oxides other than the lithium-containing composite oxide represented by general formula (1) include LiMn₂O₄, LiMn_{2-z}Me_{z}O₄ (wherein Me represents at least one element selected from the group consisting of magnesium, aluminum, zinc, iron, copper, chromium, molybdenum, zirconium, scandium, yttrium, lead, boron, antimony, and phosphorus, and z represents the range of 0.1 to 0.5).

These lithium-containing composite oxides may be used as a mixture of two or more. Examples of specific combinations for such a mixture include a mixture of LiNi_{0.8}Co_{0.15}Al_{0.05}O₂ (80 wt %) and LiNi_{1/3}Mn_{1/3}Co_{1/3}O₂ (20 wt %), a mixture of LiNi_{0.8}Co_{0.15}Al_{0.05}O₂ (80 wt %) and LiCoO₂ (20 wt %), and a mixture of LiNi_{1/3}Mn_{1/3}Co_{1/3}O₂ (30 wt %) and LiCoO₂ (70 wt %).

The average particle diameter of the lithium-containing composite oxide particles is preferably 0.2 to 40 μm, and more preferably 2 to 30 μm because of the particularly excellent discharge characteristics and cycle characteristics. Note that the average particle diameter is a value measured using a particle size distribution analyzer.

A fluorocarbon resin can be used as the binder in the positive electrode active material layer.

Specific examples of the fluorocarbon resin include polyvinylidene fluoride (PVDF), polytetrafluoroethylene (PTFE), a tetrafluoroethylene-hexafluoropropylene copolymer (FEP), and a vinylidene fluoride-hexafluoropropylene copolymer (PVDF-HFP). Of these, PVDF is preferable because of the excellent oxidation resistance and the adhesion to an electrode plate. These may be used alone or in a combination of two or more.

Note that a binder other than a fluorocarbon resin may be used as the binder contained in the positive electrode active material layer, as long as the effect of the present invention will not be impaired. Specific examples of such a binder include polyolefins such as polyethylene and polypropylene, styrene-butadiene rubber (SBR), and carboxymethyl cellulose.

The positive electrode active material layer may further contain an additive such as a conductive agent 26 as needed.

Examples of the conductive agent include graphites, carbon blacks such as acetylene black, Ketjen Black, channel black, furnace black, lamp black, and thermal black, as well as carbon fiber and various metal fibers.

The positive electrode active material layer may be formed by applying a positive electrode material mixture obtained by mixing a lithium-containing composite oxide, a binder containing a fluorocarbon resin, an additive used as needed, such as a conductive agent, and a solvent to the surface of the positive electrode current collector, followed by drying and rolling.

Specific examples of the solvent include N-methyl-2-pyrrolidone (NMP), acetone, methyl ethyl ketone, tetrahydrofuran, dimethylformamide, dimethylacetamide, tetramethylurea, and trimethyl phosphate.

The lithium-containing composite oxide content in the positive electrode active material layer is preferably in the range of 70 to 98 wt %, and specifically, it is more preferably in the range of 80 to 98 wt %.

The fluorocarbon resin content in the positive electrode active material layer is preferably in the range of 0.5 to 10 wt %, more preferably in the range of 0.7 to 8 wt %.

The proportion of the additive contained, such as a conductive agent, is preferably in the range of 0 to 20 wt %, more preferably in the range of 1 to 15 wt %.

The content ratio of the fluorocarbon resin to the lithium-containing composite oxide is preferably 0.7 to 8 parts by weight, more preferably 1 to 5 parts by weight, per 100 parts by weight of the lithium-containing composite oxide. When the content ratio of the fluorocarbon resin to the lithium-containing composite oxide is too low, the coverage of the fluorocarbon resin relative to the surface area of the lithium-containing composite oxide particles described below tends not to increase sufficiently. On the other hand, when the content ratio of the fluorocarbon resin to the lithium-containing composite oxide is too high, the coverage of the fluorocarbon resin relative to the surface area of the lithium-containing composite oxide particles tends to increase too much.

In this embodiment, the positive electrode material mixture is applied to the surface of the positive electrode current collector, followed by drying and rolling, to form a positive electrode active material layer, thereby obtaining a positive electrode, and the obtained positive electrode is heat-treated under a predetermined condition. This heat treatment is aimed at melting or softening the fluorocarbon resin. Such a heat treatment softens or melts the fluorocarbon resin that has been binding the lithium-containing composite oxide particles at points. Consequently, the fluorocarbon resin covers a wide range of the surface of the lithium-containing composite oxide particles.

The heat treatment condition can be appropriately selected according to the kind and amount of the fluorocarbon resin, or from the viewpoint of productivity. Specific examples of the heat treatment condition include the following conditions.

Specifically, when the heat treatment temperature is, for example, in the range of 250 to 350° C., the heat treatment time is set preferably in the range of 10 to 120 seconds, more preferably in the range of 20 to 90 seconds, particularly preferably in the range of 30 to 75 seconds.

When the heat treatment temperature is, for example, in the range of 220 to 250° C., the heat treatment time is set preferably in the range of 1.5 to 90 minutes, more preferably in the range of 2 to 60 minutes, particularly preferably in the range of 10 to 50 minutes.

When the heat treatment temperature is, for example, in the range of 160 to 220° C., the heat treatment time is preferably in the range of 1 to 10 hours, more preferably in the range of 2 to 8 hours, particularly preferably in the range of 2 to 7 hours.

Of the above-described ranges, the heat treatment time is set preferably in the range of 2 to 90 minutes, more preferably in the range of 10 to 60 minutes, particularly preferably in the range of 20 to 40 minutes when the heat treatment temperature is in the range of 220 to 245° C. Furthermore, when the heat treatment temperature is in the range of 245 to 250° C., the heat temperature time is set preferably in the range of 1.5 to 60 minutes, more preferably in the range of 2 to 50 minutes, particularly preferably in the range of 10 to 40 minutes.

When the heat treatment is insufficient, the coverage of the fluorocarbon resin on the surface of the lithium-containing composite oxide particles tends to decrease. On the other hand, when the heat treatment is excessive, the coverage of the fluorocarbon resin on the surface of the lithium-containing composite oxide particles tends to increase too much. When the coverage of the fluorocarbon resin on the surface of the lithium-containing composite oxide particles is not in the ranges described below, the effect of the present invention cannot be achieved sufficiently.

The coverage of the fluorocarbon resin on the surface of the lithium-containing composite oxide particles is 20 to 65%, preferably 28 to 65%, more preferably 30 to 55%. Note that the coverage of the fluorocarbon resin on the surface of the lithium-containing composite oxide particles can be determined by performing an elemental mapping of the surface of the lithium-containing composite oxide particles contained in the positive electrode active material layer using an Electron Probe Micro Analyzer (EPMA).

When the coverage of the fluorocarbon resin on the surface of the lithium-containing composite oxide particles is 20% or less, the effect of retaining metal cations eluted from the positive electrode on the surface of the positive electrode active material layer cannot be achieved sufficiently. On the other hand, when the fluorocarbon resin coverage exceeds 65%, polarization gradually increases due to an increase in the charge transfer resistance of the positive electrode, resulting in a decreased capacity.

The inventors have found that the coverage of the fluorocarbon resin on the surface of the lithium-containing composite oxide particles correlates with the contact angle between the positive electrode active material layer surface and the non-aqueous electrolyte.

That is, when the coverage of the fluorocarbon resin on the surface of the lithium-containing composite oxide particles is low, the contact angle between the positive electrode active material layer surface and the non-aqueous electrolyte is low. On the other hand, when the fluorocarbon resin coverage is high, the contact angle between the positive electrode active material layer surface and the non-aqueous electrolyte is high.

Accordingly, it is possible to indirectly determine the coverage of the fluorocarbon resin from a contact angle by associating the contact angle between the positive electrode active material layer surface and a predetermined non-aqueous electrolyte with the coverage of the fluorocarbon resin on the surface of the lithium-containing composite oxide particles that has been measured in advance by an elemental mapping. In the following, an example of this method will be specifically described in detail.

It is assumed that when an elemental mapping of the surface of lithium-containing composite oxide particles contained in a positive electrode active material layer having a predetermined composition was performed before a positive electrode including that positive electrode active material layer had been subjected to the above-described heat treatment, the coverage of the fluorocarbon resin on the surface of the lithium-containing composite oxide particles was 10%. On the other hand, it is assumed that when an elemental mapping of the surface of the lithium-containing composite oxide particles contained in the positive electrode active material layer was performed after the same positive electrode had been subjected to the heat treatment under a predetermined condition, the fluorocarbon resin coverage was 90%.

Meanwhile, the contact angle between the positive electrode active material layer surface and a predetermined non-aqueous electrolyte is measured before and after the heat treatment. At this time, it is assumed that the contact angle before the heat treatment had been performed was 10 degrees, and the contact angle after the heat treatment had been performed was 40 degrees.

Then, by varying the heat treatment condition, it is possible to obtain the correlation between a coverage in the range of 10 to 90% and a contact angle of 10 to 40 degrees.

An example of the composition of the non-aqueous electrolyte used for the contact angle measurement may be, but is not particularly limited to, a composition obtained by dissolving 1.4 mol/L LiPF₆ in a mixed solvent in which ethylene carbonate, ethylmethyl carbonate, and dimethyl carbonate are mixed in a volume ratio of 1:1:8.

When a non-aqueous electrolyte of such a composition is used, the contact angle of the positive electrode active material layer surface is in the range of 14 to 30 degrees, preferably 17 to 30 degrees, more preferably 18 to 26 degrees. When the contact angle is too low, the effect of retaining the metal cation eluted from the positive electrode on the surface of the positive electrode active material layer tends to be insufficient. On the other hand, when the contact angle is too high, polarization gradually tends to increase due to an increase in the charge transfer resistance of the positive electrode, resulting in a decreased capacity.

Next, the other constituents used in the lithium ion secondary battery 10 will be described in detail.

The negative electrode 12 includes a negative electrode current collector and a negative electrode active material layer formed on the surface of the negative electrode current collector.

Various current collectors used for the negative electrode of lithium ion secondary batteries may be used as the negative electrode current collector. Specific examples thereof include stainless steel, nickel, and copper. Of these, copper is particularly preferable. The negative electrode current collector may be any form including, for example, foil, membrane, film, and sheet. The thickness of the negative electrode current collector can be appropriately set according to the capacity, size, and the like of the battery. In general, the thickness is 1 to 500 μm.

The negative electrode active material layer contains a negative electrode active material, a binder, and, as needed, an additive such as a conductive agent.

Various compounds used as the negative electrode active material of lithium ion secondary batteries may be used as the negative electrode active material. Specific examples thereof include graphites such as natural graphite (e.g., flake graphite) and artificial graphite, various alloys, lithium metal, and nitrides of silicon or tin.

Various binders may be used as the binder used for the negative electrode active material layer. Specific examples thereof include polyolefins such as polyethylene and polypropylene, as well as SBR, PTFE, PVDF, FEP, and PVDF-HFP.

The same conductive agents as those described as being contained in the positive electrode active material layer may be used as the conductive agent.

The negative electrode active material layer is formed by applying a negative electrode material mixture obtained by mixing a negative electrode active material, a binder, an additive such as a conductive agent as needed, and a solvent to the surface of the negative electrode current collector, followed by drying and rolling.

The same solvents as those used for preparation of the positive electrode material mixture may be used for preparation of the solvent used for the negative electrode material mixture.

Examples of the separator 13 include microporous thin films having a high ion permeability, a sufficient mechanical strength, and insulating properties. Examples of such microporous thin films include thin films made of an olefin-based polymer such as polypropylene or polyethylene, a glass fiber sheet, non-woven fabric, and woven fabric. The thickness of the separator can be appropriately set according to the capacity, size, and the like of the battery, and therefore is not particularly limited. In general, the thickness is 10 to 300 μm.

A solution in which an electrolyte such as a lithium salt is dissolved in non-aqueous solvent containing a sulfone compound may be used as the non-aqueous electrolyte used for the lithium ion secondary battery 10.

Specific examples of the sulfone compound include cyclic sulfones such as sulfolane and 3-methylsulfolane, and dialkyl sulfones such as ethyl methyl sulfone, dimethyl sulfone, diethyl sulfone, isopropyl sulfone, and butyl sulfone. Of these, sulfolane, 3-methylsulfolane, and ethyl methyl sulfone are preferable, and sulfolane is more preferable, because of the effectiveness in capturing metal cations.

Examples of the non-aqueous solvent contained in the non-aqueous electrolyte other than the above-described sulfone compounds include various aprotic organic solvents. Specific examples thereof include cyclic carbonic acid esters such as ethylene carbonate (EC), propylene carbonate (PC), and butylene carbonate (BC); chain carbonic acid esters such as dimethyl carbonate (DMC), ethyl methyl carbonate (EMC), and diethyl carbonate (DEC); cyclic ethers such as tetrahydrofuran and 1,3-dioxolane; chain ethers such as 1,2-dimethoxyethane and 1,2-diethoxyethane; cyclic carboxylic acid esters such as γ-butyrolactone and γ-valerolactone; and chain esters such as methyl acetate. These may be used alone or in a combination of two or more.

Of these, a mixed solvent of a sulfone compound, a cyclic carbonic acid ester, and a chain carbonic acid ester is particularly preferable. Specific examples thereof include a combination of EC, PC, and a sulfone compound, a combination of EC, PC, DEC, and a sulfone compound, a combination of EC, DEC, and a sulfone compound, a combination of EC, EMC, DMC, and a sulfone compound, and a combination of EC, EMC, DEC, and a sulfone compound. Of these, a combination of EC, PC, DEC, and a sulfone compound is particularly preferable. Furthermore, the mixing ratio thereof is preferably such that EC:PC:DEC:sulfone compound=1 to 2:2 to 5:2 to 5:1 to 2 (volume ratio), more specifically about 2:3:3:2.

The sulfone compound content in the non-aqueous solvent is preferably 5 vol % or greater, more preferably in the range of 5 to 50 vol %, even more preferably in the range of 10 to 30 vol %, particularly preferably in the range of 10 to 20 vol %. A sulfone compound contained in the non-aqueous solvent in such a range allows metal cations to be more easily retained in the vicinity of the surface of the positive electrode active material layer. Note that a sulfone compound can be easily dissolved in a non-aqueous solvent.

When the sulfone compound content in the non-aqueous solvent is less than 5 vol %, the effect of retaining metal cations in the vicinity of the surface of the positive electrode active material layer tends to be insufficient. On the other hand, when the sulfone compound content in the non-aqueous solvent exceeds 50 vol %, in the case of using a graphite-based negative electrode, the charge-discharge reversibility tends to be reduced, resulting in a decrease in the capacity.

Ordinarily, a lithium salt is used as the electrolyte contained in the non-aqueous electrolyte.

Specific examples of the lithium salt include lithium hexafluorophosphate (LiPF₆), lithium tetrafluoroborate (LiBF₄), lithium perchlorate (LiClO₄), lithium hexafluoroantimonate (LiSbF₆), lithium hexafluoroarsenate (LiAsF₆), lithium tetrachloroaluminate (LiAlCl₄), lithium trifluoromethanesulfonate (LiCF₃SO₃), lithium trifluoroacetate (LiCF₃CO₂), lithium thiocyanate (LiSCN), lithium lower aliphatic carboxylates, chloroborane lithium (LiBCl), LiB₁₀Cl₁₀, lithium halides, lithium borate compounds, and lithium-containing imide compounds.

Specific examples of the above lithium borate compounds include lithium bis(1,2-benzenediolato(2-)-O,O′)borate, lithium bis(2,3-naphthalenediolato(2-)-O,O′)borate, lithium bis(2,2′-biphenyldiolato(2-)-O,O′)borate, and lithium bis(5-fluoro-2-olato-1-benzene sulfonate(2-)-O,O′)borate. Specific examples of the above lithium-containing imide compounds include lithium bis(trifluoromethanesulfonyl)imide [LiN(CF₃SO₂)₂], lithium(trifluoromethanesulfonyl) (nonafluorobutanesulfonyl) imide [LiN(CF₃SO₂) (C₄F₉SO₂)], and lithium bis(pentafluoroethanesulfonyl) imide [LiN(C₂F₅SO₂)₂].

The lithium salts may be used alone or in a combination of two or more. Of these, LiPF₆ and LiBF₄ are preferable, and LiPF₆ is particularly preferable.

The ratio of the lithium salt dissolved to the non-aqueous solvent is preferably approximately 0.5 to 2 mol/L.

The non-aqueous electrolyte may also contain various additives used for electrolytes.

Specific examples of such additives include those described below. The additives may be used alone or in a combination of two or more.

The following are examples of additives that increase the charge/discharge efficiency of a non-aqueous electrolyte secondary battery by being decomposed on the negative electrode surface to form a highly lithium ion-conductive coating. Specific examples include vinylene carbonate, 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate, and divinylethylene carbonate.

Examples of an additive capable of inactivating a battery at the time of overcharge by being decomposed to form a coating on an electrode include those benzene derivatives that have a phenyl group and a cyclic compound group adjacent to the phenyl group. Examples of the cyclic compound group include phenyl group, a cyclic ether group, a cyclic ester group, a cycloalkyl group, and phenoxy group. Specific examples of such benzene derivatives include cyclohexylbenzene, biphenyl, and diphenyl ether. The proportion of the above benzene derivatives contained is preferably 10 vol % or less of the entire non-aqueous electrolyte.

In the lithium ion secondary battery 10 of this embodiment during storage, in particular, storage at a high temperature, metal cations are eluted from the lithium-containing composite oxide into the non-aqueous electrolyte. The metal cations have a low electron density. On the other hand, a sulfone compound has an electron-attracting sulfonyl group in its molecules, and has a higher electron density in that portion. Also, the coating of a fluorocarbon resin formed on the surface of the positive electrode active material has electron-attracting fluorine atoms in its molecules, and has a high electron density in that portion. Therefore, the sulfone compound contained in the non-aqueous electrolyte and the fluorocarbon resin coating on the surface of the lithium-containing composite oxide particles surround and trap the metal cations eluted from the lithium-containing composite oxide.

Accordingly, with such a lithium ion secondary battery, it is possible to suppress the precipitation of the metal cations eluted from the lithium-containing composite oxide on the negative electrode surface. Consequently, it is possible to suppress the deterioration in rate characteristics even if the battery is stored at a high temperature.

An example of the method for assembling the lithium ion secondary battery 10 will be described.

As described above, first, a material mixture containing lithium-containing composite oxide particles and a fluorocarbon resin is applied to the surface of a positive electrode current collector, followed by drying and rolling to form a positive electrode active material layer, thus obtaining a positive electrode. Thus obtained positive electrode is heat-treated under the above-described condition to obtain a positive electrode 11.

Then, the positive electrode 11, a negative electrode 12, and a separator 13 disposed between the positive electrode 11 and the negative electrode 12 are laminated to give an electrode group 14. Then, the electrode group 14 is wound in a spiral. The positive electrode 11 has been electrically connected in advance to one end of a positive electrode lead 15. The negative electrode 12 has been electrically connected to one end of a negative electrode lead 16. Then, one end of the negative electrode lead 16 is electrically connected to a battery case 19, and one end of the positive electrode lead 15 is electrically connected to a positive electrode terminal 21.

Then, a positive electrode-side insulating plate 17 is mounted on one end, in the winding axis direction, of the electrode group 14, and a negative electrode-side insulating plate 18 is mounted on the other end. Then, the electrode group 14, the positive electrode-side insulating plate 17, and the negative electrode-side insulating plate 18 are housed in the battery case 19, which also serves as the negative electrode terminal.

Next, a non-aqueous electrolyte containing a sulfone compound is supplied to the battery case 19.

A sealing plate 20 placed at the end of the opening of the battery case 19. Then, the battery case 19 is sealed with the sealing plate 20 by narrowing the diameter of the battery case 19. Thus, the cylindrical lithium ion secondary battery 10 is obtained.

Although a cylindrical battery was described as a specific embodiment of the lithium ion secondary battery, the shape of the lithium ion secondary battery is not limited thereto, and can be selected from various shapes, including, for example, a square shape, a coin shape, a sheet shape, a button shape, a flat shape, and a laminated shape according to the use and the like. The lithium ion secondary battery may also be a lithium ion secondary battery using a polymer electrolyte.

Furthermore, the lithium ion secondary battery of the present invention can be preferably used as a power source for small devices, a power source for electric vehicles, and a power source for power storage.

In the following, the present invention will be described more specifically by way of examples. It should be appreciated that the scope of the invention is by no means limited to the examples.

### EXAMPLES

First, a summary of the production and the evaluation of positive electrodes used for the examples and the production of negative electrodes is provided.

### <Production of Positive Electrode>

A slurry positive electrode material mixture was prepared by mixing 85 parts by weight of LiNi_{0.82}Co_{0.15}Al_{0.03}O₂ particles with an average particle diameter 10 μm, serving as lithium-containing composite oxide particles, 5 parts by weight of polyvinylidene fluoride (PVDF), 10 parts by weight of acetylene black, and a predetermined amount of dehydrated N-methyl-2-pyrrolidone (NMP). Next, the obtained positive electrode material mixture was applied to both sides of a positive electrode current collector to form positive electrode active material layers. A 15 μm thick aluminum foil (A8021H-H18-15RK, manufactured by Nippon Foil Mfg. Co., Ltd.) was used as the positive electrode current collector. Next, the resultant laminate of the positive electrode active material layers and the positive electrode current collector was dried with 110° C. hot air. Then, the dried laminate was rolled between a pair of rolls to adjust the total thickness of the laminate to 130 μm.

Then, the rolled laminate was cut to predetermined width and length. The cut laminates were then heat-treated in a constant-temperature bath under the respective conditions described in Table 1 (treatment conditions Nos. 1 to 18). Thus, positive electrodes were obtained.

### <Evaluation of Positive Electrodes>

The PVDF coverage relative to the surface area of the lithium-containing composite oxide particles and the contact angle of the positive electrode surface were measured for the heat-treated 18 types of positive electrodes obtained in the production examples and a positive electrode that had not been heat-treated.

The PVDF coverage was measured by elemental mapping. The contact angle of the positive electrode surface was measured using a non-aqueous electrolyte obtained by dissolving 1.4 mol/L LiPF₆ in a mixed solvent in which ethylene carbonate, ethyl methyl carbonate, and dimethyl carbonate were mixed in a volume ratio of 1:1:8. Specifically, an approximately 2 μL droplet of the non-aqueous electrolyte was dropped to the surface of the positive electrode active material layer of the positive electrode, and the contact angle (degrees) 10 seconds after the dropping was measured by the θ/2 method.

The results are shown in Table 1.

TABLE 1
Positive electrode active material: LiNi_{0.82}Co_{0.15}Al_{0.03}O₂
Binder: PVDF (5 wt %)

| | Heat treatment | Contact angle | |
|---|---|---|---|
| | condition for | of positive | |
| Treatment | positive | electrode | PVDF coverage |
| condition No. | electrode | surface | [%] |
| 1 | 280° C., 150 s | 40° | 90 |
| 2 | 280° C., 130 s | 33° | 71.3 |
| 3 | 280° C., 125 s | 31° | 66.7 |
| 4 | 280° C., 120 s | 30° | 63.3 |
| 5 | 180° C., 8 h | 29° | 60.7 |
| 6 | 230° C., 50 m | 28° | 58 |
| 7 | 280° C., 90 s | 26° | 52.7 |
| 8 | 230° C., 30 m | 25° | 50 |
| 9 | 180° C., 5 h | 23° | 44.7 |
| 10 | 280° C., 60 s | 22° | 42 |
| 11 | 280° C., 40 s | 18° | 31.3 |
| 12 | 180° C., 2 h | 17° | 28.7 |
| 13 | 280° C., 20 s | 16° | 26 |
| 14 | 230° C., 10 m | 16° | 26 |
| 15 | 280° C., 10 s | 15° | 23.3 |
| 16 | 280° C., 9 s | 14° | 20.7 |
| 17 | 280° C., 8 s | 13° | 18 |
| 18 | 280° C., 5 s | 10° | 10 |
| — | Not heat- | 10° | 10 |
| | treated | | |

### <Production of Negative Electrode>

A slurry of a negative electrode material mixture was prepared by mixing 75 parts by weight of artificial graphite powder, 5 parts by weight of polyvinylidene fluoride, 20 parts by weight of acetylene black, and a proper amount of dehydrated NMP. Next, the obtained negative electrode material mixture was applied to both sides of copper foil (negative electrode current collector) to form negative electrode active material layers. Then, the laminate of the negative electrode active material layers and the negative electrode current collector was dried with 110° C. hot air. Then, the dried laminate was rolled between a pair of rolls to give a negative electrode with a total thickness of 150 μm. The obtained negative electrode was cut to predetermined width and length.

### Examples

### Examples 1 to 7, and Comparative Examples 1 to 6

Using the positive electrodes that had been heat-treated under the above-described heat treatment conditions, cylindrical lithium ion secondary batteries were produced in the following manner.

The positive electrodes that had been heat-treated under the conditions shown in Table 1 were used in Examples 1 to 7 and Comparative Examples 1 to 6, as shown in Table 2. In addition, a polyethylene microporous thin film was used as the separator.

Using the positive electrode, the negative electrode, the non-aqueous electrolyte, and the separator, cylindrical lithium ion secondary batteries as shown in FIG. 1 were produced. An aluminum lead was used as the positive electrode lead, and a nickel lead was used as the negative electrode lead. In addition, a nickel-plated iron case was used as the battery case.

A mixed solvent with a sulfolane content of 20 vol % in which ethylene carbonate (EC), propylene carbonate (PC), diethyl carbonate (DEC), and sulfolane (SL) were mixed in a ratio (volume ratio) of 2:3:3:2 was used as the non-aqueous solvent of the non-aqueous electrolyte. Then, LiPF₆ was dissolved in this mixed solvent to a concentration of 1.0 mol/L. Thus, a non-aqueous electrolyte was prepared.

Then, the amount of metal precipitated on the negative electrode and the capacity recovery rate after high temperature storage of each of the obtained lithium ion secondary batteries were measured by the following method.

(Measurement of the Amount of Metal Precipitated on the Negative Electrode after High Temperature Storage)

Each of the obtained lithium ion secondary batteries was fully charged by constant-current and constant-voltage charging with a voltage of 4.2 V. The charged lithium ion secondary batteries were then stored at 85° C. for 72 hours.

Then, the stored lithium ion secondary batteries were disassembled, and the negative electrode was removed. Then, a cut piece measuring 2 by 2 centimeters was cut out from a central portion of the negative electrode. Then, the cut piece was washed with ethyl methyl carbonate three times. Next, the washed cut piece was placed in an acidic solution (aqueous nitric acid solution), and thereafter heated to 100° C. to separate it into the negative electrode current collector and the negative electrode active material layer. Then, the insoluble matter was filtered off from the acidic solution, and thereafter the filtrate was diluted to a given volume to prepare a sample.

Then, the elementary composition of the obtained sample was measured with an inductively coupled plasma (ICP) emission spectral analyzer (VISTA-RL, manufactured by VARIAN, INC.). Then, the amount of metal eluted from the positive electrode to be precipitated on the negative electrode was calculated based on the nickel and cobalt contents in the sample. In addition, the amount of metal precipitated was converted into amount per unit weight of the negative electrode. Note that the measurement of the aluminum content was omitted because the content was very small.

### (Measurement of Capacity Recovery Rate)

Each of the obtained lithium ion secondary batteries was subjected to constant-current and constant-voltage charging at 20° C. Specifically, first, the batteries were charged with a constant current of 1050 mA until the battery voltage reached 4.2 V. Next, the batteries were charged with a constant voltage of 4.2 V for two and a half hours. Furthermore, the charged batteries were discharged with a discharge current value of 1500 mA (1 C) until the battery voltage dropped to 2.5 V. The discharge capacity at this time was used as the storage discharge capacity before storage [Ah].

Next, the discharged battery was further subjected to constant-current and constant-voltage charge under the same condition as described above. Then, the battery that had undergone the second charge was stored at 85° C. for 72 hours. Then, the stored battery was discharged at 20° C. under the condition of a discharge current value of 1 C, and was further discharged under the condition of a discharge current value of 0.2 C. Next, the discharged battery was charged with a constant voltage of 4.2 V for two and a half hours. Further, the charged battery was discharged under the condition of a discharge current value of 1 C until the battery voltage dropped to 2.5 V. The discharge capacity at this time was used as the recovered capacity after storage [Ah].

The ratio of the recovered capacity after storage [Ah] to the discharge capacity before storage [Ah] was calculated to determine the capacity recovery rate after high temperature storage [%].

The results are shown in Table 2.

TABLE 2
Positive electrode active material: LiNi_{0.82}Co_{0.15}Al_{0.03}O₂
Binder: PVDF (5 wt %)
Non-aqueous solvent: EC + PC + DEC + SL (Volume ratio 2:3:3:2)

| | Heat | | | |
|---|---|---|---|---|
| | treatment | | | |
| | condition | PVDF | Amount of | Recovery |
| | for positive | coverage | precipitation | rate |
| | electrode | [%] | [μg/g] | [%] |
| Com. Ex. 1 | No. 1 | 90 | 5.1 | 57.4 |
| Com. Ex. 2 | No. 2 | 71.3 | 5.2 | 74.0 |
| Com. Ex. 3 | No. 3 | 66.7 | 5.3 | 76.3 |
| Example 2 | No. 4 | 63.3 | 5.5 | 80.8 |
| Example 3 | No. 7 | 52.7 | 5.8 | 85.2 |
| Example 1 | No. 10 | 42 | 6.0 | 88.5 |
| Example 4 | No. 11 | 31.3 | 8.6 | 84.9 |
| Example 5 | No. 13 | 26 | 14 | 80.5 |
| Example 6 | No. 15 | 23.3 | 15 | 80.3 |
| Example 7 | No. 16 | 20.7 | 17 | 80.0 |
| Com. Ex. 4 | No. 17 | 18 | 20 | 75.1 |
| Com. Ex. 5 | No. 18 | 10 | 28 | 67.9 |
| Com. Ex. 6 | Not heat- | 10 | 33 | 64.6 |
| | treated | | | |

In Table 2, the positive electrodes of Examples 1 to 7 are positive electrodes in which the PVDF coverage on the surface of LiNi_{0.82}Co_{0.15}Al_{0.03}O₂ particles is in the range of 20 to 65%, or positive electrodes in which the contact angle of the positive electrode surface is in the range of 14 to 30 degrees. It can be seen that in the lithium ion secondary batteries of Examples 1 to 7, the amount of metal precipitated on the negative electrode after high temperature storage was less than 17 μg/g. Furthermore, the capacity recovery rate after high temperature storage was 80% or greater. This result demonstrates that the deterioration in rate characteristics was suppressed even after high temperature storage.

Meanwhile, in the lithium ion secondary batteries of Comparative Examples 1 to 3 as well, in which positive electrodes with a PVDF coverage exceeding 65% or a contact angle of 30 degrees was used, the amount of metal precipitated on the negative electrode after high temperature storage was small. However, the capacity recovery rate was less than 80%.

In the lithium ion secondary batteries of Comparative Examples 4 to 6, in which positive electrodes with a PVDF coverage of less than 20% or a contact angle of less than 14 degrees was used, the amount of metal precipitated on the negative electrode after high temperature storage was 20 μg/g or greater. Furthermore, the capacity recovery rate was less than 80%.

### Examples 8 to 9, and Comparative Examples 7 to 10

Lithium ion batteries were produced and evaluated in the same manner as in Example 1 except that the composition of the non-aqueous solvent of the non-aqueous electrolyte was changed as shown in Table 3. A non-aqueous solvent containing 3-methylsulfolane (3MeSL) in place of sulfolane was used in Example 8. A non-aqueous solvent containing ethyl methyl sulfone (EMS) in place of sulfolane was used in Example 9. A sulfone compound-free non-aqueous solvent in which EC, EMC, and DMC were mixed in a volume ratio of 1:1:8 was used in Comparative Example 7. A sulfone compound-free non-aqueous solvent in which EC, PC, and DEC were mixed in a volume ratio of 3:3:4 was used in Comparative Example 8. Although a non-aqueous solvent containing a sulfone compound was used in Comparative Examples 6 to 9, a positive electrode that had not been heat-treated and had a PVDF coverage of 10% was used.

The results are shown in Table 3, together with the results for Example 1 and Comparative Example 6.

TABLE 3

| | Heat | | | Amount of | Recovery |
|---|---|---|---|---|---|
| | treatment | Coverage | Sulfone | precipitation | rate |
| | condition | [%] | compound | [μg/g] | [%] |
| Example 1 | No. 10 | 42 | SL | 6.0 | 88.5 |
| Example 8 | No. 10 | 42 | 3MeSL | 6.2 | 87.6 |
| Example 9 | No. 10 | 42 | EMS | 6.5 | 87.0 |
| Com. | No. 10 | 42 | *1 | 58 | 47.1 |
| Ex. 7 | | | | | |
| Com. | No. 10 | 42 | *2 | 56 | 49.5 |
| Ex. 8 | | | | | |
| Com. | Not-heat | 10 | SL | 33 | 64.6 |
| Ex. 6 | treated | | | | |
| Com. | Not-heat | 10 | 3MeSL | 35 | 63.8 |
| Ex. 9 | treated | | | | |
| Com. | Not-heat | 10 | EMS | 37 | 62.5 |
| Ex. 10 | treated | | | | |

*Positive electrode active material: LiNi_{0.82}Co_{0.15}Al_{0.03}O₂
*Binder: PVDF (5 wt %)
*Non-aqueous solvent: EC + PC + DEC + Sulfone compound (Volume ratio 2:3:3:2)
*Non-aqueous solvent (Volume ratio)
*1 (Com. Ex. 7): EC + EMC + DMC (1:1:8)
*2 (Com. Ex. 8): EC + PC + DEC (3:3:4)

As shown in Table 3, all of the lithium ion secondary batteries of Example 1, 8, and 9 showed a small amount of metal precipitated on the negative electrode after high temperature storage and a high capacity recovery rate. In particular, Example 1, in which sulfolane was used, and Example 8, in which 3-methylsulfolane was used, showed a particularly small amount of precipitation of metal and a high capacity recovery rate. On the other hand, Comparative Examples 7 and 8, in which sulfone compound-free non-aqueous solvents were used, showed a very large mount of precipitation of metal and a low capacity recovery rate.

### Examples 10 to 15

Lithium ion secondary batteries were produced and evaluated in the same manner as in Example 1 except that the composition of the non-aqueous solvent of the non-aqueous electrolyte was changed as shown in Table 4.

The results are shown in Table 4.

TABLE 4
Positive electrode active material: LiNi_{0.82}Co_{0.15}Al_{0.03}O₂
Binder: PVDF (5 wt %)
Heat treatment condition for positive electrode: No. 10 (280° C., 60
seconds)
PVDF coverage: 42% (Contact angle of positive electrode surface: 22°)

| | | Amount of | |
|---|---|---|---|
| | Non-aqueous solvent | precipitation | Recovery rate |
| | (Volume ratio) | [μg/g] | [%] |
| Example 10 | EC + PC + DEC + SL | 8.3 | 85.2 |
| | (2:3:4.5:0.5) | | |
| Example 11 | EC + PC + DEC + 3MeSL | 8.6 | 84.7 |
| | (2:3:4.5:0.5) | | |
| Example 12 | EC + PC + DEC + EMS | 9.0 | 84.1 |
| | (2:3:4.5:0.5) | | |
| Example 13 | EC + PC + SL | 7.1 | 86.8 |
| | (5:4:1) | | |
| Example 14 | EC + PC + 3MeSL | 7.4 | 86.2 |
| | (5:4:1) | | |
| Example 15 | EC + PC + EMS | 7.6 | 86.0 |
| | (5:4:1) | | |

As shown in Table 4, all of the lithium ion secondary batteries of Examples 10 to 15 showed a small amount of precipitation of metal and a high capacity recovery rate.

### Examples 16 to 22, and Comparative Examples 11 to 16

Positive electrodes were produced in the same manner as described in “Production of positive electrode” except that LiNi_{1/3}Mn_{1/3}Co_{1/3}O₂ particles with an average particle diameter 10 μm were used as the lithium-containing composite oxide particles in place of LiNi_{0.82}Co_{0.15}Al_{0.03}O₂ particles with an average particle diameter of 10 μm. The treatment conditions for the positive electrodes were the same as conditions Nos. 1 to 18 described in Table 1.

However, in the measurement of the amount of metal precipitated using an ICP emission spectral analyzer, the amount of metal eluted from the positive electrode to be precipitated on the negative electrode was calculated based on the nickel, manganese, and cobalt contents in each sample.

Then, Lithium ion secondary batteries were produced and evaluated in the same manner as in Examples 1 to 7, and Comparative Examples 1 to 6 shown in Table 2 except that the types of the positive electrodes were changed as shown in Table 5. The correlation between the contact angle of the positive electrode surface and the PVDF coverage was the same as that of the positive electrodes using LiNi_{0.82}Co_{0.15}Al_{0.03}O₂.

TABLE 5
Positive electrode active material: LiNi_{1/3}Mn_{1/3}Co_{1/3}O₂
Binder: PVDF (5 wt %)
Non-aqueous solvent: EC + PC + DEC + SL (Volume ratio 2:3:3:2)

| | Heat treatment | | | |
|---|---|---|---|---|
| | condition for | PVDF | Amount of | Recovery |
| | positive | coverage | precipitation | rate |
| | electrode | [%] | [μg/g] | [%] |
| Com. Ex. 11 | No. 1 | 90 | 4.5 | 61.1 |
| Com. Ex. 12 | No. 2 | 71.3 | 4.7 | 77.2 |
| Com. Ex. 13 | No. 3 | 66.7 | 4.8 | 79.0 |
| Example 16 | No. 4 | 63.3 | 5.1 | 82.3 |
| Example 17 | No. 7 | 52.7 | 5.5 | 87.5 |
| Example 18 | No. 10 | 42 | 5.8 | 89.8 |
| Example 19 | No. 11 | 31.3 | 7.6 | 86.5 |
| Example 20 | No. 13 | 26 | 10 | 82.7 |
| Example 21 | No. 15 | 23.3 | 12 | 82.4 |
| Example 22 | No. 16 | 20.7 | 15 | 81.9 |
| Com. Ex. 14 | No. 17 | 18 | 18 | 78.0 |
| Com. Ex. 15 | No. 18 | 10 | 23 | 69.9 |
| Com. Ex. 16 | Not-heat | 10 | 28 | 67.6 |
| | treated | | | |

In Table 5, the positive electrodes of Examples 16 to 22 are positive electrodes in which the PVDF coverage on the surface of LiNi_{1/3}Mn_{1/3}Co_{1/3}O₂ particles was in the range of 20 to 65% or positive electrodes in which the contact angle of the positive electrode surface was in the range of 14 to 30 degrees. It can be seen that in the lithium ion secondary batteries of Examples 16 to 22, the amount of metal precipitated on the negative electrode after high temperature storage was 15 μg/g or less. Furthermore, the capacity recovery rate after high temperature storage was 80% or greater. This result demonstrates that the deterioration in rate characteristics was suppressed even after high temperature storage.

Meanwhile, in the lithium ion secondary batteries of Comparative Examples 11 to 13 as well, in which positive electrodes with a PVDF coverage exceeding 65% or a contact angle exceeding 30 degrees were used, the amount of metal precipitated on the negative electrode after storage was small. However, the capacity recovery rate was less than 80%.

In the lithium ion secondary batteries of Comparative Examples 14 to 16, in which the PVDF coverage was less than 20% or the contact angle was less than 14 degrees, the amount of metal precipitated on the negative electrode after high temperature storage was 18 μg/g or greater. Furthermore, the capacity recovery rate was less than 80%.

The lithium ion secondary battery according to one aspect of the present invention described above in detail is characterized by including: a positive electrode, a negative electrode, a separator disposed between the positive electrode and the negative electrode, and a non-aqueous electrolyte, wherein the non-aqueous electrolyte includes a non-aqueous solvent including a sulfone compound, the positive electrode includes a positive electrode current collector and a positive electrode active material layer formed on the surface of the positive electrode current collector, the positive electrode active material layer includes lithium-containing composite oxide particles and a fluorocarbon resin, and a coverage of the fluorocarbon resin relative to the surface area of the lithium-containing composite oxide particles is 20 to 65%.

With such a lithium ion secondary battery, the fluorocarbon resin covering the surface of the lithium-containing composite oxide particles serving as the positive electrode active material and the sulfone compound contained in the non-aqueous solvent surround and capture metal cations other than lithium ions that have been eluted from the lithium-containing composite oxide. Accordingly, even if such metal cations are eluted during storage at a high temperature, the precipitation of metal cations in the form of metals on the negative electrode and the separator will be suppressed. Consequently, it is possible to suppress the deterioration in rate characteristics over time.

The method for producing a lithium ion secondary battery according to another aspect of the present invention is characterized by including the steps of: (A) applying a material mixture including lithium-containing composite oxide particles and a fluorocarbon resin to the surface of a positive electrode current collector, followed by drying and rolling, to form a positive electrode active material layer, thereby obtaining a positive electrode; (B) heat-treating the positive electrode to melt or soften the fluorocarbon resin; (C) producing an electrode group by laminating the heat-treated positive electrode, a negative electrode, and a separator disposed between the positive electrode and the negative electrode; and (D) housing the electrode group and a non-aqueous electrolyte in a battery case, and sealing the battery case; wherein the non-aqueous electrolyte includes a non-aqueous solvent including a sulfone compound, a ratio of the fluorocarbon resin mixed in the material mixture is 0.7 to 8 parts by weight, per 100 parts by weight of the lithium-containing composite oxide particles, and the heat treatment is performed under such a condition that a coverage of the fluorocarbon resin relative to the surface area of the lithium-containing composite oxide particles becomes 20 to 65%.

With such a production method, it is possible to adjust the fluorocarbon resin coverage on the surface of the lithium-containing composite oxide particles in a predetermined range by adjusting the heat treatment condition.

### INDUSTRIAL APPLICABILITY

With the present invention, it is possible to provide a lithium ion secondary battery having excellent storage characteristics at high temperatures.

### DESCRIPTIONS OF REFERENCE NUMERALS

10 Cylindrical lithium ion secondary battery, 11 Positive electrode, 12 Negative electrode, 13 Separator, 14 Electrode group, 15 Positive electrode lead, 16 Negative electrode lead, 17 Positive electrode-side insulating plate, 18 Negative electrode-side insulating plate, 19 Battery case (Negative electrode terminal), 20 Sealing plate, 21 Positive electrode terminal, 22 Positive electrode current collector, 23 Positive electrode active material layer, 24 Positive electrode active material (Lithium-containing composite oxide particles), 25 Fluorocarbon resin, 26 Conductive material

1. A lithium ion secondary battery comprising:
a positive electrode, a negative electrode, a separator disposed between said positive electrode and said negative electrode, and a non-aqueous electrolyte,
wherein said non-aqueous electrolyte comprises a non-aqueous solvent comprising a sulfone compound,
said positive electrode comprises a positive electrode current collector and a positive electrode active material layer formed on the surface of said positive electrode current collector,
said positive electrode active material layer comprises lithium-containing composite oxide particles and a fluorocarbon resin, and
a coverage of said fluorocarbon resin relative to the surface area of said lithium-containing composite oxide particles is 20 to 65%.

2. The lithium ion secondary battery in accordance with claim 1, wherein said non-aqueous solvent comprises 5 to 50 vol % of a sulfone compound.

3. The lithium ion secondary battery in accordance with claim 1, wherein said fluorocarbon resin is polyvinylidene fluoride.

4. The lithium ion secondary battery in accordance with claim 1, comprising 0.7 to 8 parts by weight of said fluorocarbon resin per 100 parts by weight of said lithium-containing composite oxide particles.

5. The lithium ion secondary battery in accordance with claim 1, wherein said sulfone compound is at least one selected from the group consisting of sulfolane, 3-methylsulfolane, and ethyl methyl sulfone.

6. The lithium ion secondary battery in accordance with claim 1, wherein said sulfone compound is sulfolane.

7. The lithium ion secondary battery in accordance with claim 1,
wherein said lithium-containing composite oxide particles comprise a lithium-containing composite oxide represented by the following general formula (1):
LiₓM_{y}Me_{1-y}O_{2+δ} (1)
wherein M represents at least one element selected from the group consisting of nickel, cobalt, and manganese; Me represents at least one element selected from the group consisting of magnesium, aluminum, zinc, iron, copper, chromium, molybdenum, zirconium, scandium, yttrium, lead, boron, antimony, and phosphorus; x is in the range of 0.98 to 1.1; y is in the range of 0.1 to 1; and δ is in the range of −0.1 to 0.1.

8. The lithium ion secondary battery in accordance with claim 1, wherein said positive electrode has a surface having a contact angle of 14 to 30 degrees with a non-aqueous electrolyte obtained by dissolving 1.4 mol/L LiPF₆ in a mixed solvent in which ethylene carbonate, ethylmethyl carbonate, and dimethyl carbonate are mixed in a volume ratio of 1:1:8.

9. A method for producing a lithium ion secondary battery, comprising the steps of:
(A) applying a material mixture comprising lithium-containing composite oxide particles and a fluorocarbon resin to the surface of a positive electrode current collector, followed by drying and rolling, to form a positive electrode active material layer, thereby obtaining a positive electrode;
(B) heat-treating said positive electrode to melt or soften said fluorocarbon resin;
(C) producing an electrode group by laminating said heat-treated positive electrode, a negative electrode, and a separator disposed between said positive electrode and said negative electrode; and
(D) housing said electrode group and a non-aqueous electrolyte in a battery case, and sealing said battery case;
wherein said non-aqueous electrolyte comprises a non-aqueous solvent comprising a sulfone compound,
a ratio of said fluorocarbon resin mixed in said material mixture is 0.7 to 8 parts by weight, per 100 parts by weight of said lithium-containing composite oxide particles, and
said heat treatment is performed under such a condition that a coverage of said fluorocarbon resin relative to the surface area of said lithium-containing composite oxide particles becomes 20 to 65%.

10. The method for producing a lithium ion secondary battery in accordance with claim 9, wherein said fluorocarbon resin is polyvinylidene fluoride.

11. The method for producing a lithium ion secondary battery in accordance with claim 9, wherein said condition of said heat treatment is a condition of performing said heat treatment at a temperature of 250 to 350° C. for 10 to 120 seconds.

12. The method for producing a lithium ion secondary battery in accordance with claim 9, wherein said condition of said heat treatment is a condition of performing said heat treatment at a temperature of 220 to 250° C. for 2 to 60 minutes.

13. The method for producing a lithium ion secondary battery in accordance with claim 9, wherein said condition of said heat treatment is a condition of performing said heat treatment at a temperature of 160 to 220° C. for 1 to 10 hours.

14. The method for producing a lithium ion secondary battery in accordance with claim 9, wherein said non-aqueous solvent comprises 5 to 50 vol % of a sulfone compound.
